(19) United States
(12) Patent Application Publication
(10) Pub. No.: US 2016/0026536 A1
(43) Pub. Date: Jan. 28, 2016

(54) RECOVERY PATH SELECTION DURING DATABASE RESTORE

(71) Applicant: NetApp, Inc., Sunnyvale, CA (US)

(72) Inventor: Venudhar Poluri, Bangalore (IN)

(21) Appl. No.: 14/341,077

(22) Filed: Jul. 25, 2014

(51) Int. Cl. G06F 11/14

(52) U.S. Cl. CPC G06F 11/1451; G06F 2201/80

(57) ABSTRACT

A recovery path of a number of different potential recovery paths associated with a database backup can be automatically determined. Log backups for a database can be created. The log backups that are created after a full backup of the database are associated with the full backup and form a recovery path. Upon detecting restoration of a database, a new full backup can be automatically performed. Log backups subsequent to the creation of the new full backup are associated with the new full backup forming an alternative recovery path. For a restore operation, a user can select a desired full backup. Upon selection of the desired full backup, the recovery path appropriate to the selected full backup is determined by identifying the sequence of log backups associated with the selected full backup. The database restoration operation can then be performed using the selected full backup and the appropriate log backups.

### BACKGROUND

Aspects of the disclosure generally relate to the field of databases, and, more particularly, to recovery path selection for database operations.

Many applications use databases to store and maintain data. In order to provide protection against data corruption or loss, databases may be periodically backed up. A database backup may be a full database backup, in which all of the data in the database is copied (e.g., a snapshot of the database is taken) and stored, or it may be an incremental backup in which a portion of the data that has changed since the last database backup is copied and stored.

If it becomes desirable to restore a database, the full database backup and the sequence of incremental backups can be applied to a restored database to get to a desired recovery point. In order to restore the database to a particular recovery point, an unbroken sequence of incremental backups is typically required. Such incremental backups can take a variety of forms which may depend on the provider of the database system. For example, the incremental backup can be a transaction log backup or a redo log backup where database operations occurring after a previous backup or point in time are stored. The incremental backup can also be referred to as a differential backup where data that has changed since a previous backup or other point in time are stored. Where this sequence of incremental backups starts typically depends on which full backup is selected for use in the restoration of the database. For example, only incremental backups made after the most recent full backup may be used as part of the restoration of the database.

However, in some cases, it may be desirable to recover a database to a previous point in time that is older than the most recent incremental or log backup. For example, due to system or operator error, the most recent log backups may contain corrupted or erroneous data. When this happens, the database is recovered to an old state (e.g., a state prior to the one or more corrupted log backups). Any log backups that are taken on the restored database cause a recovery fork with a new recovery path created. Thus, a first recovery path includes the log backups taken before the restoration. A second recovery path includes log backups prior to the time that is specified in a point in time restore (e.g., on or before the point in time to be used for restoration) and the log backups taken after the restoration. In other words, the second recovery path will have the log backups except those which are between the time chosen as point-in-time and the time at which the restore operation is performed. As a result, there can be multiple log recovery paths for a given full backup.

Maintaining multiple recovery paths becomes increasingly difficult as the number of recovery forks grows. Even when a database operator chooses to preserve only the latest recovery path, it becomes very difficult to identify the log backups corresponding to the old recovery paths.

### SUMMARY

Log backups for a database can be created. The log backups that are created after a full backup of the database are associated with the full backup and form a recovery path. Upon detecting restoration of a database, a new full backup can be automatically performed. Log backups subsequent to the creation of the new full backup are associated with the new full backup forming an alternative recovery path. The association can be made using one or more of a backup identifier, a time stamp, a sequence number etc. Further restorations of the database may occur over time. At each restoration, a new full backup can be created that starts a new recovery path. For a restore operation, a user can select a desired full backup. Upon selection of the desired full backup, the recovery path appropriate to the selected full backup is determined by identifying the sequence of log backups associated with the selected full backup. The database restoration operation can then be performed using the selected full backup and the appropriate log backups.

### BRIEF DESCRIPTION OF THE DRAWINGS

Features of the disclosure may be better understood by referencing the accompanying drawings.

FIG. 1 depicts a system for managing recovery branches.

FIG. 2 illustrates an example timeline of database restoration and log backups that include multiple recovery branches.

FIG. 3 illustrates an example timeline including a full database backup taken after a database restore operation.

FIG. 4 illustrates associating a collection of log backups with full database backups using time stamps.

FIG. 5 illustrates a collection of log backups associated with full database backups using a backup identifier.

FIG. 6 illustrates a collection of log backups associated with full database backups using an association table.

FIG. 7 is a flow chart illustrating example operations for associating incremental database backups with a full database backup.

FIG. 8 is a flow chart illustrating example operations for automatically determining a recovery branch that includes incremental database backups associated with a full backup.

FIG. 9 is a flow chart illustrating example operations for deleting recovery branches having incremental database backups that are associated with a full backup having a creation date that is past a retention period.

FIG. 10 illustrates an example computer system.

### DETAILED DESCRIPTION

The description that follows includes example systems, methods, techniques, instruction sequences and computer program products that embody techniques of the disclosure. However, it is understood that the described features may be practiced without these specific details. For instance, although examples refer to log backups (e.g., transaction log backups), other forms of incremental database backups may be used. For example, differential backups, redo log backups, or other forms of incremental backups may be used. In other cases, well-known instruction instances, protocols, structures and techniques have not been shown in detail in order not to obfuscate the description.

Log backups that are created after a full backup of a database are associated with the full backup and form a recovery path. Upon detecting restoration of a database, an application on a storage system element such as a management application can automatically perform a new full backup. Log backups subsequent to the creation of the new full backup are associated with the new full backup forming an alternative recovery path. The association can be made using one or more of a backup identifier, a time stamp, a sequence number etc. Further restorations of the database may occur over time. At each restoration, the management application can perform a full backup that forms a new recovery path. The management application associates the new recovery path with the full backup. Over time, numerous recovery paths may exist, with each recovery path including log backups that are associated with a different full backup. For a restore operation or any similar operation such as cloning a database, a user can select a desired full backup. Upon selection of the desired full backup, the management application can determine the recovery path appropriate to the selected full backup by identifying a sequence of log backups. The database restoration operation can then be performed using the selected full backup and the appropriate log backups.

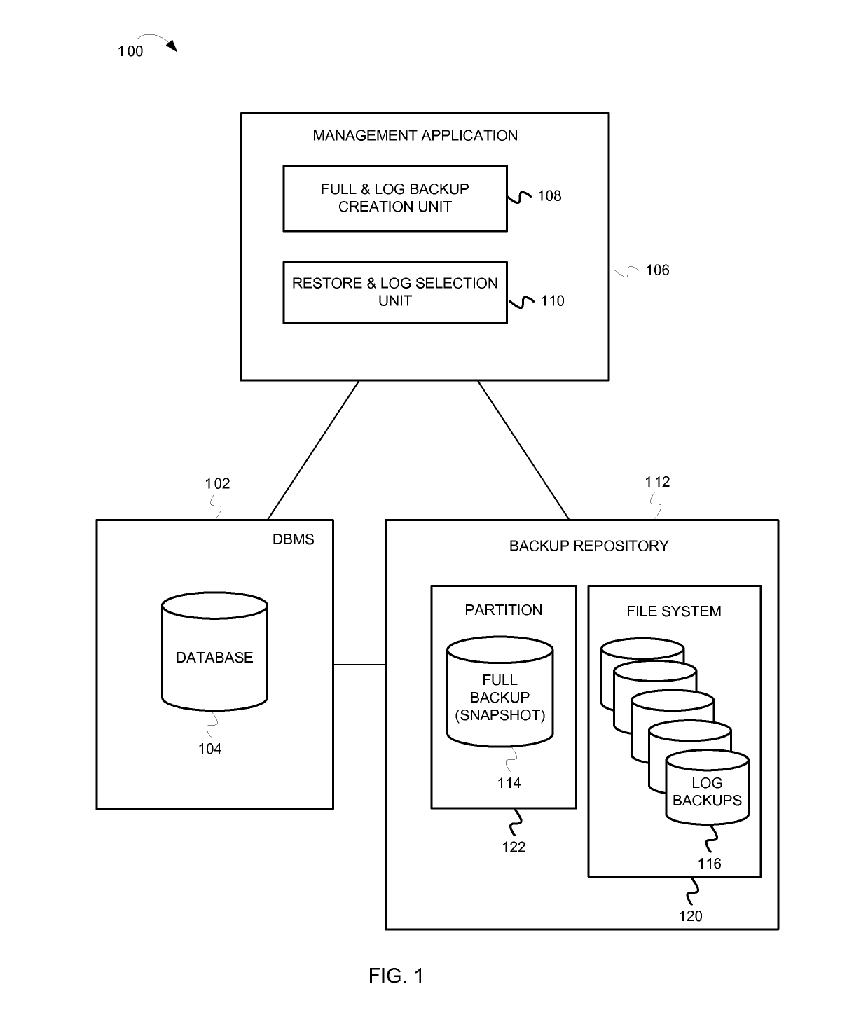

FIG. 1 depicts a system 100 for managing recovery branches. System 100 includes a database management system (DBMS) 102, a management application 106 and a backup repository 112. DBMS 102 maintains database 104. Database 104 can be a relational database having tables, columns, indexes, etc., common to relational databases. Alternatively, database 104 can be an object oriented database, a hierarchical database, or any other type of database. The disclosure is not limited to any particular type of database. As an example, DBMS 102 can be an Oracle® database system, a Microsoft® SQL Server® database system, or any other database management system.

According to some features, backup repository 112 maintains the full backups 114 and the log backups 116. Backup repository 112 can be some or all of a disk partition 122, a set of one or more files in a file system 120, or a combination of the two. Disk partition 122 and file system 120 can be on a local disk, a LUN (logical unit) in a SAN (Storage Area Network), or any other storage unit in a storage subsystem. Full backup 114 can be a backup copy or a snapshot of database 104. Full backup 114 represents the complete set of data in database 104 at the point in time that the full backup was made. Full backup 114 can be created using backup tools provided by the DBMS 102 (e.g., native tools). Such backups may be referred to as native backups. Additionally, full backup 114 can be created using file system or partition tools that are provided separately from DBMS 102. For example, the Microsoft Volume Shadow Copy Service (VSS) can be used to create a snapshot copy of database 104. Other tools that create a snapshot of the database 104 can be used. A backup that comprises a snapshot copy can typically be made in a shorter time relative to the time typically required for backups made using tools native to the DBMS 102. In the example illustrated in FIG. 1, full backup 114 is shown as residing in partition 122. However, in some aspects, full backup 114 may be one or more files in file system 120.

The file system 120 that maintains the log backups 116 can be any type of file system. The file system can be local to a system 100, or it can be a distributed file system.

Log backups 116 are incremental backups that are created after full backup 114 is created. Each log backup contains data that has been updated since a previous log backup. As an example, log backups 116 can be transaction log backups or redo log backups. Each log backup contains transactions that have been performed after a previous log backup was created. Alternatively, log backups 116 can be incremental or differential backups, where each log backup contains data that has changed after a previous log backup was created. If a database restoration is desired, some or all of the log backups 116 can be applied to a given full backup 114. The log backups are typically applied in the order that the log backups were taken. The log backups 116 in a file system 120 may be associated with different full backups as will be further described below.

In the example illustrated in FIG. 1, database 104 is stored in a database partition that is separate from backup partition 122 and file system 120 that maintains the log backups 116. In alternative aspects, database 104 may be stored in the same partition 122 that stores backups or snapshots of the databases or in the same file system 120 as log backups 116. Although one database 104 and one full backup 106 are illustrated in FIG. 1, a system 100 may include more than one database and more than one full backup.

Management application 106 is an application that manages and controls aspects of the operation of database management system 102. For example, management application 106 may include functions and policies that create database backups (both full backup 114 and log backups 116) and may include functions to restore and recover a database 104 from a full backup 114 and one or more log backups 116. These backups could be manually taken or there can be policies that determine when backups are taken. As an example, a policy may indicate that a full backup is to be created every day and log backups are to be created every hour. In some examples, management application 106 is the NetApp® SnapManager® application for SQL Server application available from NetApp, Inc. of Sunnyvale, Calif. Management application 106 includes a full and log backup creation unit 108. The management application 106 also includes a restoration and log selection unit 110 that automatically selects log backups 116 that belong to full backup for database management system 102.

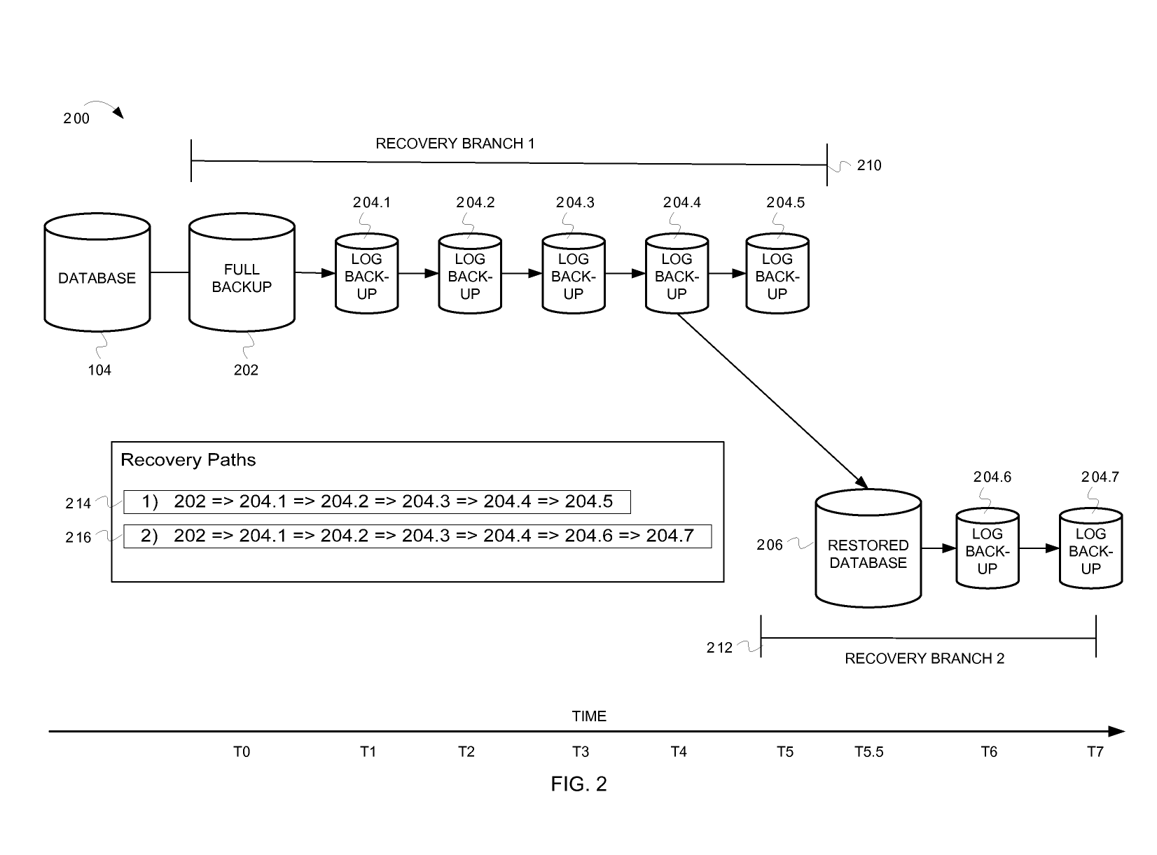

FIG. 2 illustrates an example timeline 200 of database restoration and log backups that include multiple recovery branches. For the purposes of the example, assume that at time t=0, a full backup 202 is made of database 104. After creation of full backup 202, a series of incremental backups are created. For example, at time t=1, log backup 204.1 is created. Later, at time t=2, log backup 204.2 is created. Similarly, at times t=3 through t=5, log backups 204.3-204.5 are created. For the purposes of the example, assume that at some point in time between t=4 and t=5, erroneous data is introduced into database 104. Thus, at time t=5, log backup 204.5 can include the erroneous data, while log backup 204.4 does not include the erroneous data. Thus the database operator may desire to restore the database to a point in time prior to t=5. The database operator can perform a restore operation on database 206 at time t=5.5 (i.e., at some point in time between t=5 and t=6) by using full backup 202 to create an initial version of restored database 206 and then applying log backups 204.1-204.4 to the restored database 206 to bring the restored database 206 to the state of database 104 as of time t=4. Log backup 204.5 is not applied because it contains the erroneous data. After restoration of the database 206, at times t=6 and t=7, log backup 204.6 and log backup 204.7 may be created, with further log backups being created as time goes on.

In order to restore a database from a full backup to a particular point in time, relevant log backups among the available log backups (e.g., log backups 204.1-204.7) can be applied in a sequence after the full backup is applied. The log backups can be applied in the order of the time the log backups were taken. In some aspects, a log sequence number (LSN) may be available in each log backup or full backup header. The LSN may be used to determine the order of a log backup in a sequence of log backups. The LSN can be used to identify the first log backup to be applied after the full backup. Subsequent log backups can be applied in the order of time or LSN one after the other until the log backup corresponding to the desired point in time is reached.

As can be seen in FIG. 2, two recovery paths exist over time. A first recovery path 214 includes log backups 204.1-204.5 from the recovery branch 210 that can be applied to full backup 202. A second recovery path 216 includes log backups 204.1 to 204.4 from recovery branch 210 and log backups 204.6, 204.7 from recovery branch 212 that can be applied to the same full backup 202. Even though log backup 204.6 and log backup 204.7 occur after t=5 they cannot be applied on top of log backup 204.5 because log backups 204.6 and 204.7 are taken after the database 104 is restored to a previous point in time. However the log backups 204.6 and 204.7 can be applied after log backup 204.4 is applied.

The example illustrated in FIG. 2 includes two recovery branches 210 and 212 and two recovery paths 214 and 216. However, in a typical case, there can be multiple databases and there can be many different recovery branches for each of the databases, resulting in many different potential recovery paths. When there are multiple recovery branches, it can be extremely difficult to identify the desired recovery path with the right sequence of log backups that can be applied after a full back up in order to restore a database to a desired state or point in time.

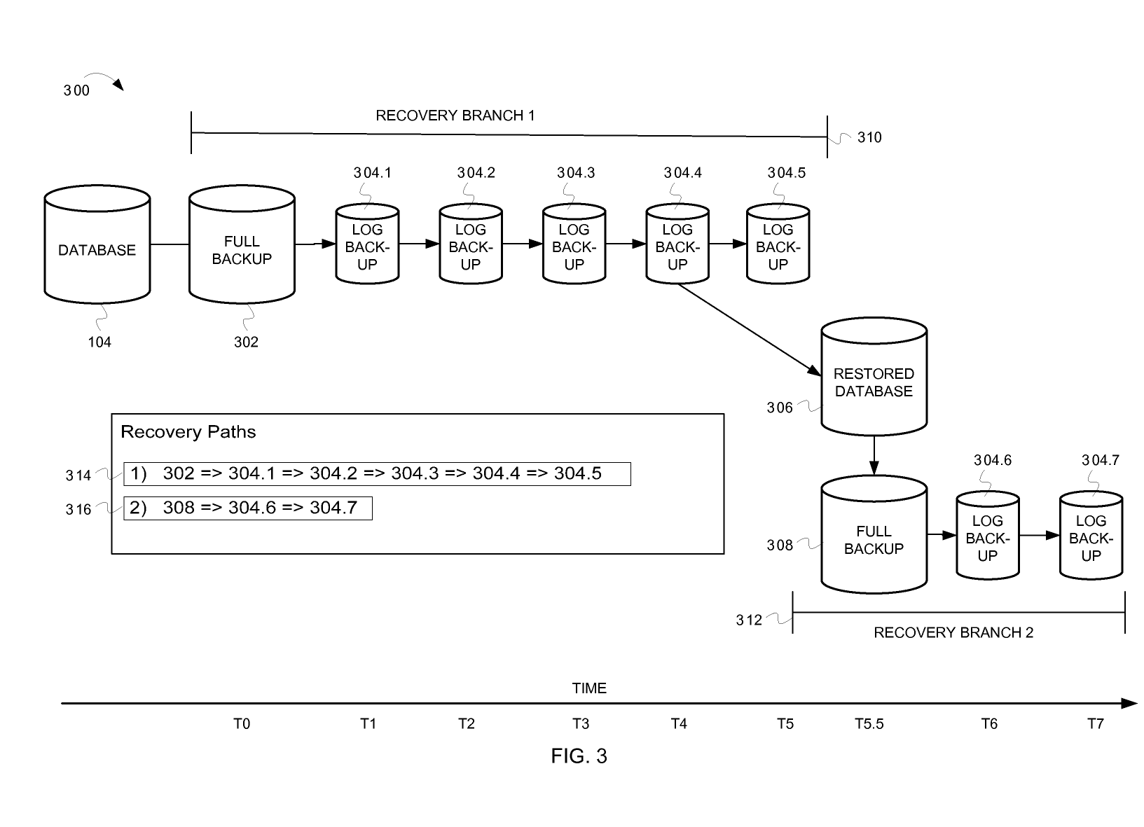

FIG. 3 illustrates an example timeline including a new full backup taken immediately after a database restoration. In the example illustrated in FIG. 3, a series of log backups are applied to a previous full backup 302 to create restored database 306. According to some features of the disclosure, a new full backup 308 is automatically created in response to the restoration of the database. For example, management application 106 (FIG. 1) can cause a snapshot or native full backup 308 of the restored database 306 to be performed. As noted above, a snapshot backup can be desirable as it can typically be completed more rapidly than a native backup. After creation of full backup 308, log backups 304.6 and 304.7 can be created. For example, log backups 304.6 and 304.7 may be created according to a backup schedule or policy.

A full backup can be associated to a list of log backups in a sequence. Thus management application 106 associates log backups from 304.1-304.5 with full backup 302. Log backups 304.6, 304.7 created after the full backup 308 is created are associated to the full backup 308. The possible recovery paths are retained here, yet there is a single recovery path that is associated to any given full backup. Thus according to some aspects of the disclosure, upon selection of a particular full backup one recovery path and the corresponding log backups can be readily determined based on the selected full backup.

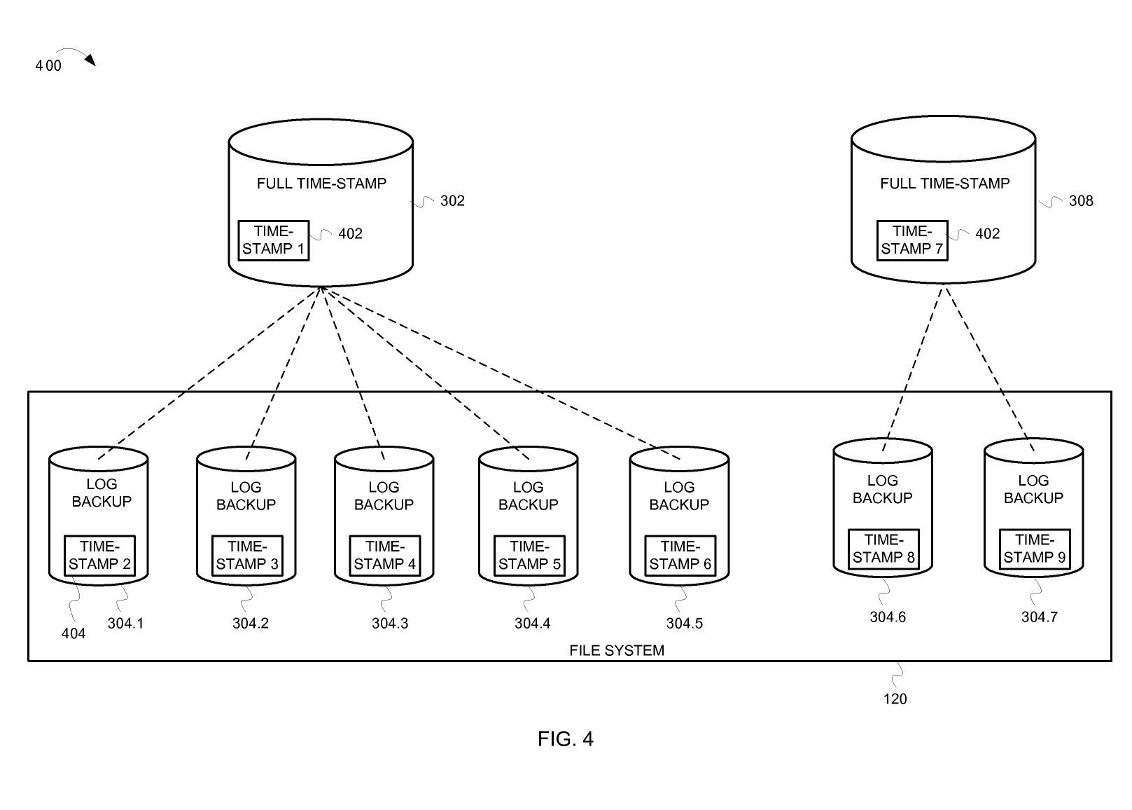

FIG. 4 illustrates associating a collection of log backups with full database backups using time stamps. Continuing with the example illustrated in FIG. 3, a first full backup 302 of a database is created and given a time stamp 402. The time stamp 402 may be maintained in various ways. For example, the time stamp may be provided in a data record or header of the full backup 302. Alternatively, the time stamp 402 may be a time stamp that is associated with a file maintained in a file system that comprises the backup 302. Other mechanisms for providing a time stamp may be used.

As log backups are created (e.g., log backups 304.1-304.7), the log backups are also provided a time stamp 404 indicating the time the log backup was created. As with the backup time stamp 402, the log backup time stamp 404 may be in a data record or header in the log backup or it may be maintained as a file system time stamp associated with the file that comprises the log backup.

In the example illustrated in FIG. 4, time stamps 402 and 404 are shown as having a value of “time stamp n”, where n is used in the figure to indicate a time order. Thus “time stamp 1” is a time value that represents a point in time before “time stamp 2”, which is a time value that represents a point in time before “time stamp 3,” etc. A management application or other application can associate log backups with full backups using the time stamps. In the example illustrated in FIG. 4, log backups 304.1-304.5 having time stamp values 2-6 respectively are associated with full backup 302, because their respective time stamp values occur after the full backup 302 and before the database restoration 306. Log backups 304.6, 304.7 are not associated to the full backup 302 because they occurred after the database restoration 306. In some aspects, other information from the backup information can be used to determine the log backups that can be applied to a full backup. For example, LSN values and RecoveryID details can be used to determine that log backups 304.6, 304.7 cannot be applied to the full backup 302. If the database restoration had not taken place and if the log backups occur in the same order, then full backup 302 could be associated to the log backups from 304.1-304.7. However, in the example illustrated in FIG. 4, log backups 304.6 and 304.7 having time stamps 8 and 9 respectively can be associated with full backup 308 because they occur after the time that full backup 308 was created (e.g., after “time stamp 7”).

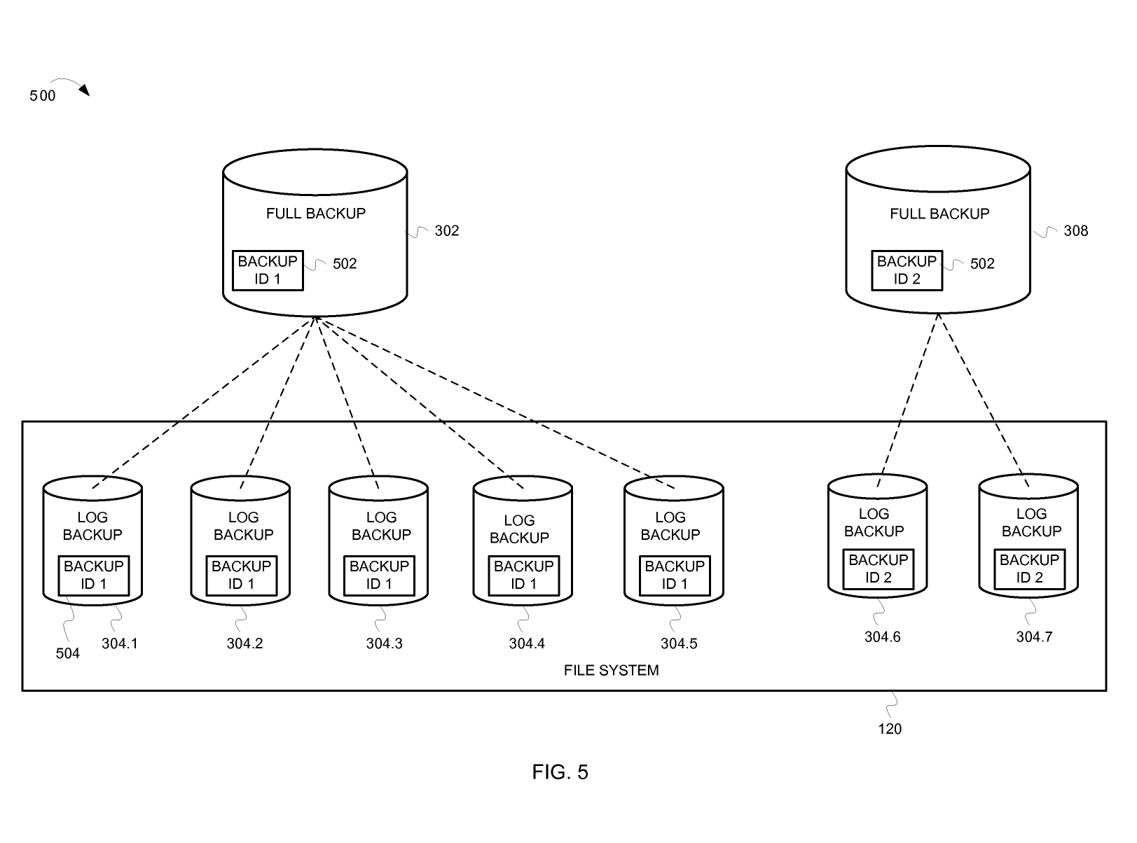

FIG. 5 illustrates associating a collection of log backups with full database backups using a backup identifier. In some aspects of the disclosure, a full backup (e.g., full backup 302 and 308) is assigned a backup identifier 502. Continuing with example illustrated in FIG. 3, FIG. 5 illustrates a full backup 302 that, upon creation, is assigned a backup identifier 502, indicated as “BACKUP IDENTIFIER 1”. As an example, in systems utilizing SQL Server, when a full backup is created, an identifier referred to as a “last_recovery_fork id” (also referred to as a “RecoveryForkId”) is assigned to the full backup. The RecoveryForkId can be used as a backup identifier 502. In the example shown in FIG. 5, a RecoveryForkId is assigned to the full backup 302 (created at time t=0 in FIG. 3). Log backups 304.1-304.7 also have a backup identifier 504. The system assigns a value for backup identifier 504 of log backups 304.1-304.5 (created from full backup 302) that is the same value as that of backup identifier 502 of the full backup 302. For example, in SQL Server based systems, the log backups 304.1-304.5 can be assigned the same RecoveryForkID value as used for backup identifier 502 for full backup 302. Similarly, full backup 308 (created at time t=5.5 in FIG. 3) is assigned a different value for backup identifier 502 (e.g., a different RecoveryForkId) because the full backup 308 is taken after creation of restoration database 306 in FIG. 3. Also, the subsequent log backups 304.6 and 304.7 are assigned the same value for backup identifier 504 (e.g., the same RecoveryForkId) as the identifier value assigned to backup identifier 502 for full backup 308.

Management application 106 (FIG. 1) can separate the various chains of log backups based on the backup identifier 504 and associate the log backups to their corresponding full backup. Thus for the full backup 302, log backups from 304.1-304.5 can be selected and applied for a database operation. Log backup 304.6 will not be applied after 304.5, because log backup 304.6 will have a different value for backup identifier 504 (e.g., a different RecoveryForkID). Likewise, for full backup 308 the log backups 304.6 and 304.7 can be automatically selected and applied based on the match between the value of backup identifier 502 in full backup 308 and the values of log backup identifier 504 in log backups 304.6 and 304.7. The choice of a first log backup to be applied to a given full backup can be based on a timestamp or a sequence number such as an LSN, The backup identifier can be used in addition to, or instead of the time and LSN. In other words the management application 106 can split the log backups into separate chains or sequences of log backups that comprise a recovery path based on combinations of some or all of time stamps, LSNs and backup identifiers.

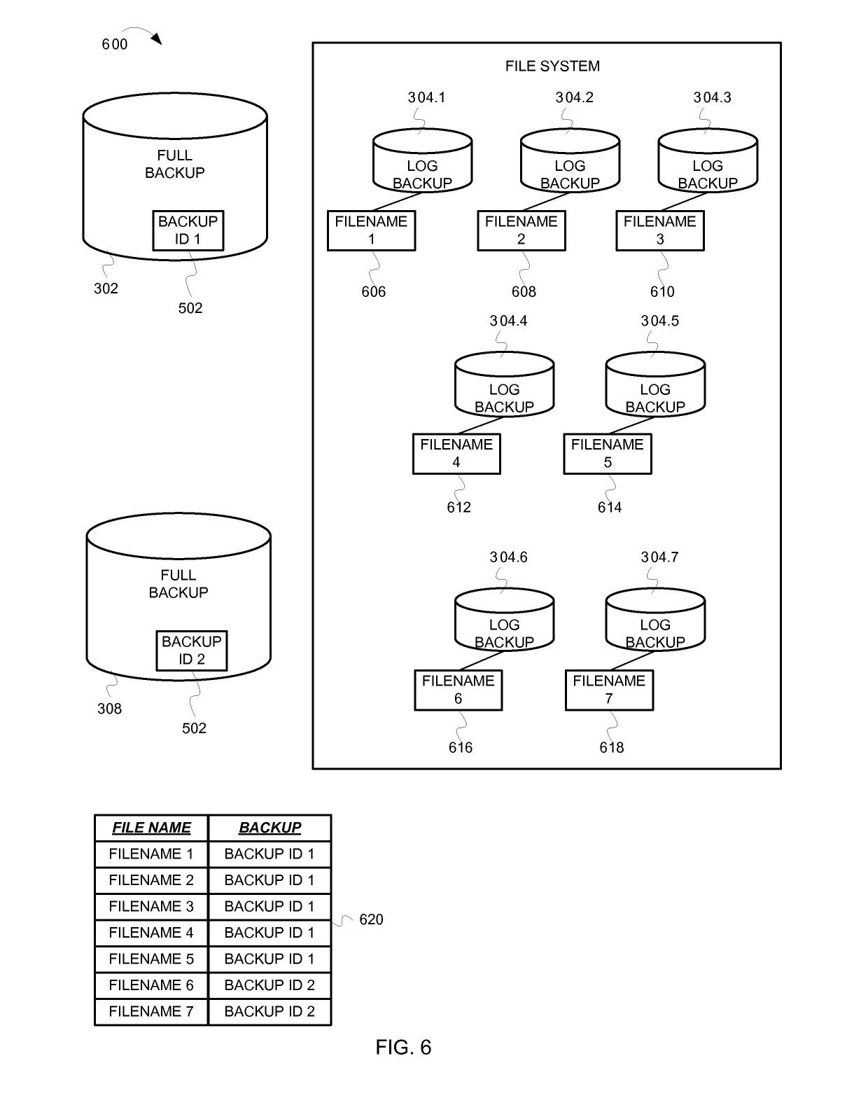

FIG. 6 illustrates associating a collection of log backups with full database backups utilizing an association table. Again continuing with the example illustrated in FIG. 3, a feature of alternative aspects of the disclosure utilizes a table 620 to associate a file name of a log backup (e.g., log backups 304.1-304.7) in a file system with a backup identifier 502 of a full database backup. In the example illustrated in FIG. 6, each of log backups 304.1-304.7 includes a file name that can be used to uniquely identify the log backup in the file system. Table 620 provides an association of file names to full backup identifiers. Thus in the example illustrated in FIG. 6, table 620 associates file names representing log backups 304.1-304.5 with backup identifier 502 value “BACKUP ID 1” assigned to full backup 302. Table 620 associates file name 616 and file name 618 with backup identifier 502 value “BACKUP ID 2” assigned to full backup 308. Other identifiers can be used to associate log backups with their corresponding full backup. For example, table 620 can associate a full backup name with the log backup file names.

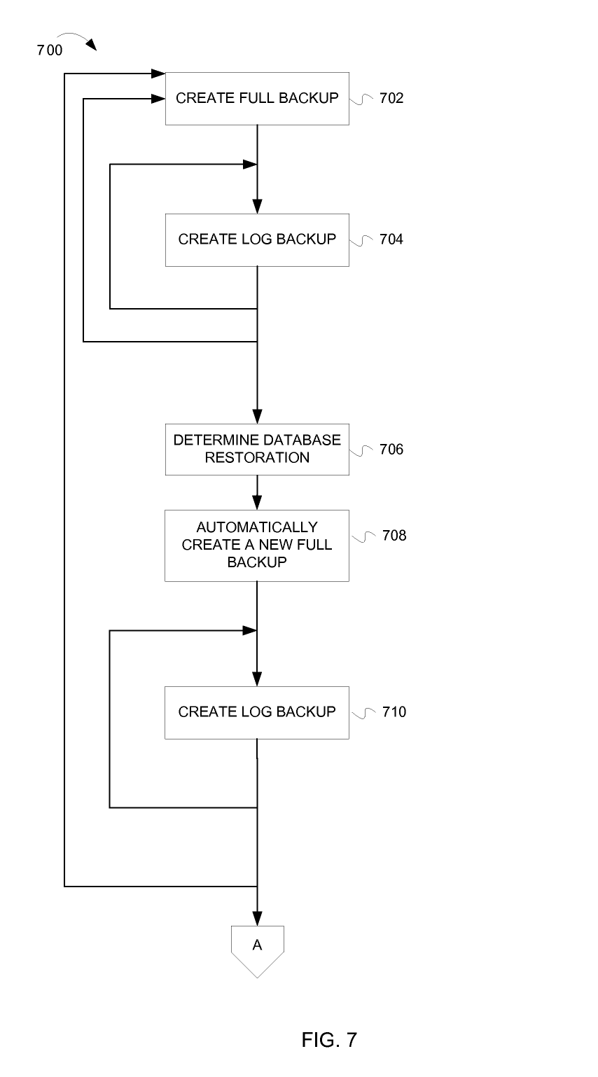

FIG. 7 is a flow chart 700 illustrating example operations for associating log backups with a full database backup. At block 702, a full backup is created. The full backup can be a snapshot of a database or other type of backup that creates a complete copy of the data in a database. The full backup can be automatically created according to a schedule or policy. Alternatively, a full backup may be created by manually by invoking a backup tool

At block 704, a log backup of the database is created. As discussed above, a log backup is an incremental backup of changes to the database that have been committed since a previous log backup. The log backup can be any type of incremental backup, including a transaction log backup, a redo log backup, a differential backup, etc. Log backups may be automatically created according to a schedule or policy. Alternatively, a log backup may be created by manually invoking a backup tool.

Blocks 702 and 704 may be repeated as desired such that a series of full backups and log backups are created. The log backups that are created after a full backup are associated to the full backup using any of the methods described above. A log backup chain can be continued (e.g., additional log backups added to the chain) until a database restoration occurs (assuming none of the log backups in the sequence are deleted or otherwise missing).

At block 706 a determination is made that a database has been restored. For example, a management application 106 (FIG. 1) may determine that a database has been restored in response to receiving a command to restore a database followed by successful restoration of the database.

At block 708, a full backup of the database that was restored at block 708 is created. One aspect is that the full backup may be created automatically in response to detecting that a database has been restored. An alternative feature is that an operator may be prompted to create a full backup of the restored database.

At block 710, a subsequent log backup (i.e., a log backup created after the full backup created at block 710) can be created. The subsequent log backups may be created according to a schedule or policy. Alternatively, some or all of the subsequent log backups may be created with a backup tool.

Block 710 may be repeated as desired such that a series of log backups may be taken. Again this workflow may be repeated, as the full backups and log backups can be continued to be taken as per a scheduled policy or by manual creation.

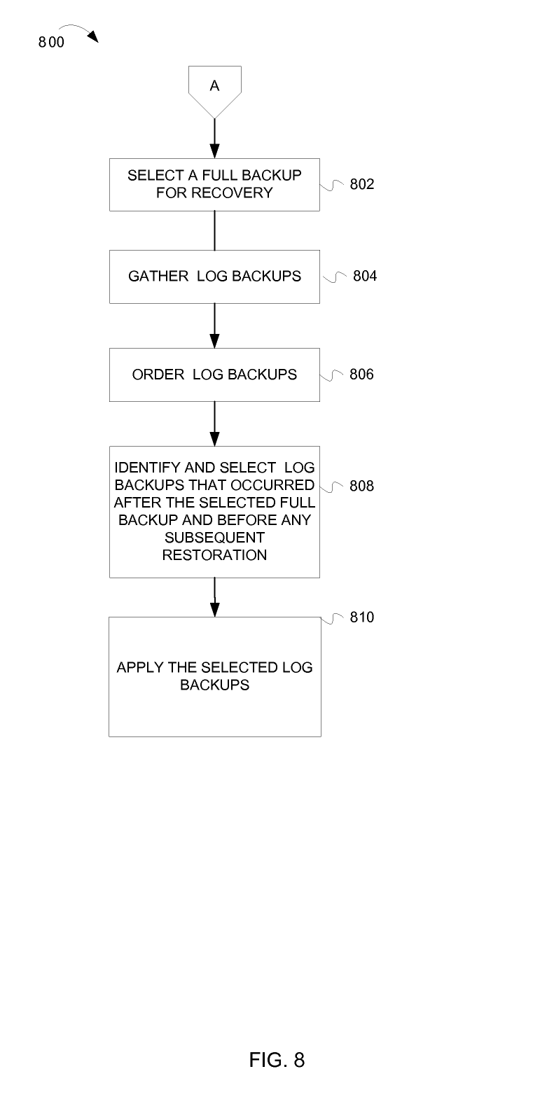

FIG. 8 is a flow chart 800 illustrating example operations for automatically determining a recovery path that includes log backups associated with a selected full backup. At block 802 a database recovery operation is initiated. For example, a database recovery operation may comprise an operation or command to restore a database to a particular point in time after creation of a full backup of the database. In such an example, a user may select a full backup to be used to restore the database.

At block 804, the management application reads the information of available log backups. The available backups may be located by scanning a file system for appropriate files or file types, or by scanning one or more directories or folders specified by a configuration for the database management system.

At block 806, the log backups are ordered. In some aspects, the backups can be ordered by time, for example, by using timestamps associated with the log backups. In alternative aspects, the log backups can ordered by LSN values.

At block 808, the management application automatically identifies a recovery path that includes log backups taken after the full backup selected at block 802 and before any subsequent restoration of the database (if any). If there is no restoration identified then the log backups till the latest log backup are associated to the full backup selected at 802. In some aspects, the log backups can be associated to the full backup by using the backup identifier and time stamp or LSN values. The first log backup that is to be applied to the full backup selected at block 802 can be identified by using an earliest time stamp or a lowest sequence number along with the backup identifier. The first selected log backup can then be used in the desired database operation (e.g., a restore operation).

At block 810, the selected log backups are presented for restoration one after the other in the order of time, LSN values or both time and LSN values

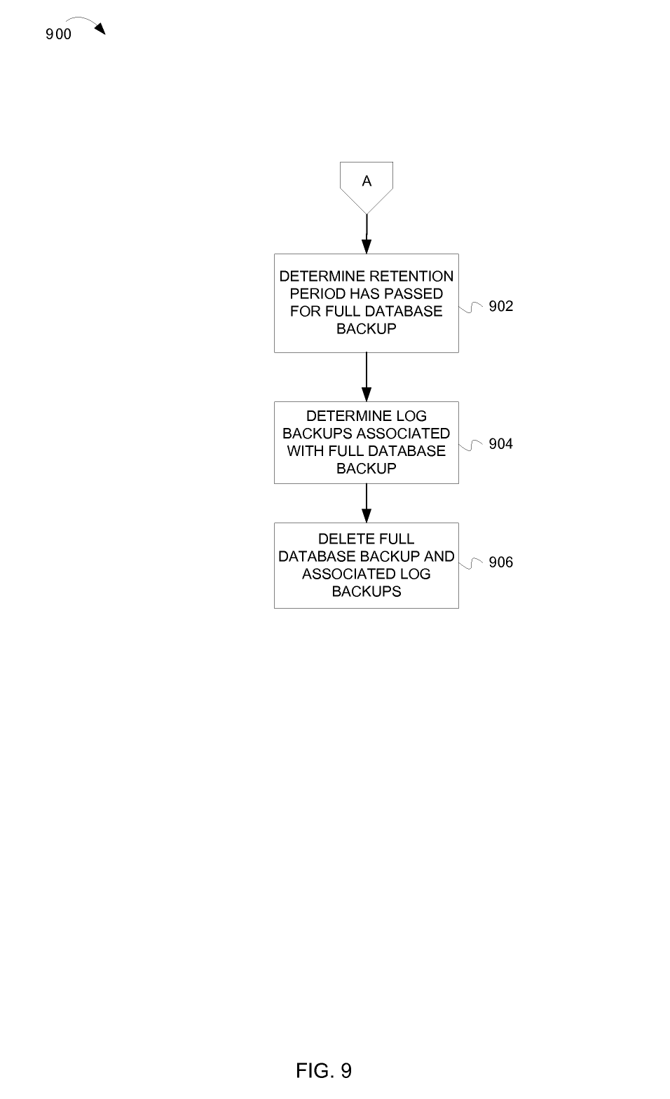

FIG. 9 is a flow chart 900 illustrating example operations for deleting recovery paths having log backups that are associated with a full backup. As an example, a database manager may specify a retention period. Backups and log backups having a creation date that is past the retention period are deleted. At block 902, a system executing the operations (e.g., management system 106, FIG. 1) determines that a retention period has passed for a particular full database backup. For instance, a database operator may determine that full backups are to be retained for two months. Thus, a full backup that is over two months old can be deleted from the system in order to make room on a storage device for new backups or new databases.

At block 904, the management application determines which log backups are associated with the full backup that has been determined to be past its retention period. One aspect is that the backup identifier associated with the full backup may be used to determine backup logs associated with the full backup. For example, the management system may search for log backups in a file system that have been tagged with the backup identifier of the full backup. Alternatively, a table 620 (FIG. 6) may be used to determine file names of log backups that are associated with a full backup that is past its retention period.

At block 906, the full backup and the log backups that have been determined to be associated with the full backup can be deleted.

As will be appreciated from the above, some aspects of the disclosure preserve the recovery points of a database. As a result, a database operator can restore a database using any of the log backups that exist. The restore/recovery process can be initiated by choosing a full backup. A single recovery path can be automatically determined, thus the user does not have to manually determine recovery paths. Irrespective of the number of the recovery branches or forks that are created over time, a single recovery path for a given full backup can be determined.

As will be appreciated by one skilled in the art, aspects of the disclosure may be embodied as a system, method or computer program product. Accordingly, aspects of the disclosure may take the form of entirely hardware, entirely software (including firmware, resident software, micro-code, etc.) or a combination of software and hardware aspects that may all generally be referred to herein as a “circuit,” “module” or “system.” Furthermore, aspects of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device. A computer readable storage medium does not encompass a transitory propagating signal.

A computer readable signal medium may include a propagated data signal with computer readable program code embodied therein, for example, in baseband or as part of a carrier wave. Such a propagated signal may take any of a variety of forms, including, but not limited to, an electro-magnetic signal, an optical signal, an infrared signal, or any suitable combination thereof. A computer readable signal medium may be any computer readable medium that is not a computer readable storage medium and that can communicate, propagate, or transport a program for use by or in connection with a computer. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone computer, may execute in a distributed manner across multiple computers, and may execute on one computer while providing results and or accepting input on another computer.

Aspects of the disclosure are described with reference to flowchart illustrations and/or block diagrams of methods, apparatus (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

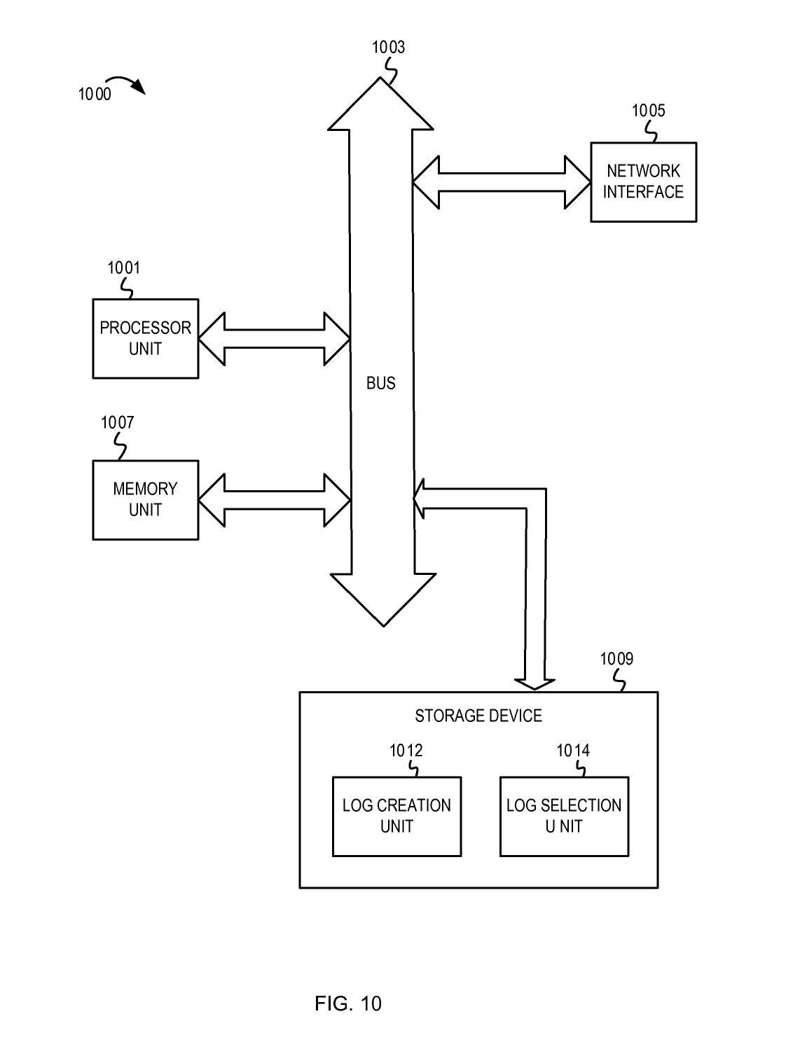

FIG. 10 depicts an example computer system. A computer system includes a processor unit 1001 (possibly including multiple processors, multiple cores, multiple nodes, and/or implementing multi-threading, etc.). The computer system includes memory 1007. The memory 1007 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 1003 (e.g., PCI, ISA, PCI-Express, HyperTransport®, InfiniBand®, NuBus, etc.), a network interface 1005 (e.g., an ATM interface, an Ethernet interface, a Frame Relay interface, SONET interface, wireless interface, etc.), and a storage device(s) 1009 (e.g., optical storage, magnetic storage, etc.). The system memory 1007 and/or storage device 1009 includes functionality to implement features described above. For example, storage device 1009 may store instructions and data for log creation unit 1012 and log selection unit 1014 that facilitate associating log backups with corresponding full backups to automatically identify recovery branches. Any one of these functionalities may be partially (or entirely) implemented in hardware and/or on the processing unit 1001. For example, the functionality may be implemented with an application specific integrated circuit, in logic implemented in the processing unit 1001, in a co-processor on a peripheral device or card, etc. Further, realizations may include fewer or additional components not illustrated in FIG. 10 (e.g., video cards, audio cards, additional network interfaces, peripheral devices, etc.). The processor unit 1001, the storage device(s) 1009, and the network interface 1005 are coupled to the bus 1003. Although illustrated as being coupled to the bus 1003, the memory 1007 may be coupled to the processor unit 1001.

While the aspects of the disclosure are described with reference to various features and exploitations, it will be understood that these features are illustrative and that the scope of the disclosure is not limited to them. In general, techniques for associating log backups with full backups to automatically identify recovery paths as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

What is claimed is:

1. A method comprising:
creating a first set of one or more incremental database backups for a database;
associating, by one or more processors, the first set of one or more incremental database backup with a first full database backup of the database;
receiving a request to initiate a database operation, the request identifying the first full database backup;
in response to receiving the request, automatically determining a recovery path including the first set of one or more incremental database backups associated with the first full database backup; and
performing the requested database operation using the recovery path.

2. The method of claim 1, wherein the first set of one or more incremental database backups comprise one or more log backups and wherein the one or more log backups are associated with the first full database backup using a backup identifier.

3. The method of claim 1, wherein the recovery path excludes incremental database backups occurring after a restoration operation on the database.

4. The method of claim 1, further comprising ordering the one or more incremental database backups.

5. The method of claim 1, further comprising:
receiving a request to perform a full restoration of the database using the first full database backup;
in response to the request, restoring the database from the first full database backup and the first set of one or more incremental database backups associated with the first full database backup to create a restored database; and
automatically creating a second full database backup.

6. The method of claim 5, further comprising associating a second set of one or more incremental database backups created subsequent to creation of the second full database backup with the second full database backup.

7. The method of claim 1, further comprising:
determining that a third full database backup is past a retention period;
determining a third set of one or more incremental backups associated with the third full database backup; and
deleting the third full database backup and the third set of one or more incremental backups associated with the third full database backup.

8. A non-transitory machine readable medium having stored thereon instructions comprising machine executable code which when executed by a machine, causes the machine to:
create a first set of one or more incremental database backups;
associate the first set of one or more incremental database backup with a first full database backup;
receive a request to initiate a database operation, the request identifying the first full database backup;
in response to the request, automatically determine a recovery path including the first set of one or more incremental database backups associated with the first full database backup; and
perform the requested database operation using the recovery path.

9. The non-transitory machine readable medium of claim 8, wherein the first set of one or more incremental database backups comprise one or more log backups and wherein the one or more log backups are associated with the first full database backup using a backup identifier.

10. The non-transitory machine readable medium of claim 8, wherein the recovery path excludes incremental database backups occurring after creation of a second full database backup.

11. The non-transitory machine readable medium of claim 8, wherein the machine executable code further includes machine executable code cause the machine to order the first set of one or more incremental database backups.

12. The non-transitory machine readable medium of claim 11, wherein the first set of one or more incremental database backups are ordered by a timestamp value.

13. The non-transitory machine readable medium of claim 8, wherein the machine executable code further includes machine executable code to cause the machine to:
receive a request to perform a full restoration of the database using the first full database backup;
in response to the request, restore the database from the first full database backup and the first set of one or more incremental database backups associated with the first full database backup to create a restored database; and
automatically create a second full database backup.

14. The non-transitory machine readable medium of claim 13, wherein the machine executable code further includes machine executable code to cause the machine to associate a second set of one or more incremental database backups created subsequent to creation of the second full database backup with the second full database backup.

15. The non-transitory machine readable medium of claim 8, wherein the machine executable code further includes machine executable code to cause the machine to:
determine that a third full database backup is past a retention period;
determine a third set of one or more incremental backups associated with the third full database backup; and
delete the third full database backup and the third set of one or more incremental backups associated with the third full database backup.

16. An apparatus comprising:
a processor; and
a machine readable storage medium having machine executable code stored therein that is executable by the processor to cause the apparatus to:
receive a request to perform a full restoration of a database using a first full database backup;
determine a recovery path associated with the full database backup, wherein the recovery path includes a first set of one or more incremental database backups associated with the first full backup, wherein the recovery path includes incremental backups created after the first full backup and excludes incremental backups created after a restoration of the database occurring after the first full backup;
in response to the request, restore the database from the first full database backup and recovery path associated with the first full database backup to create a restored database; and
automatically create a second full database backup of the restored database.

17. The apparatus of claim 16, wherein the machine executable code further includes machine executable code to cause the machine to:
create the first set of one or more incremental database backups; and
associate the first set of one or more incremental database backup with the first full database backup.

18. The apparatus of claim 16, wherein the machine executable code further includes machine executable code cause the machine to order the first set of one or more incremental database backups by a sequence number.

19. The apparatus of claim 16, wherein the first set of one or more incremental database backups are ordered by a sequence number.

20. The apparatus of claim 16, wherein the machine executable code further includes machine executable code to cause the machine to associate a second set of one or more incremental database backups created subsequent to creation of a second full database backup for the database with the second full database backup.
